(19) United States
(12) Patent Application Publication
(10) Pub. No.: US 2005/0079779 A1
(43) Pub. Date: Apr. 14, 2005

(54) Reinforced polymer composites

(75) Inventors: David G. McLeod, Rochester, MI (US); Frank J. Flavin, Midland, MI (US); Bart Jones, Midland, MI (US); Teli R. Samar, Rochester Hills, MI (US)

Correspondence Address: Richard W. Hoffmann, PO Box 70098, Rochester Hills, MI, 48307, US

(73) Assignee: Dow Global Technologies Inc., Midland, MI (US)

(21) Appl. No.: 10/918,943

(22) Filed: Aug. 16, 2004

Related U.S. Application Data
(63) Continuation-in-part of application No. 10/310,169, filed on Dec. 4, 2002, now Pat. No. 6,793,261.

(51) Int. Cl. B32B 27/12; B32B 27/04; B32B 15/08; B32B 5/02; D03D 9/00

(52) U.S. Cl. 442/6; 442/19; 442/43

(57) ABSTRACT

A polymer composite is described. The polymer composite includes at least one polymer component and at least one metal mesh component. The metal mesh component can be disposed within the polymer component or may be disposed on a surface thereof. The polymer composite is particularly well adapted for use as automotive components, such as but not limited to wheel well assemblies.

### CROSS-REFERENCE TO RELATED APPLICATION

The instant application is a continuation-in-part of U.S. patent application Ser. No. 10/310,169 filed Dec. 4, 2002, pending, the entire specification of which is expressly incorporated herein by reference.

### FIELD OF THE INVENTION

The present invention relates generally to polymer composites and more particularly to reinforced polymer composites.

### BACKGROUND OF THE INVENTION

Presently, in order to strengthen polymeric materials, fillers, such as fiberglass, minerals, and carbon fibers are used. In some instances, the glass fibers in the polymer form a mat. In other instances, polymer composites are made from glass filled or glass reinforced random fiber utilizing an injection molding process.

Conventional polymer composite materials, especially those used in structural applications for the automotive industry, do not always possess sufficient strength characteristics under all environmental conditions, especially cold weather conditions. Thus, when these conventional polymer composite materials are subjected to certain forces, e.g., impact forces, especially in cold weather conditions, they have a tendency to fracture and fail.

Accordingly, there exists a need, particularly in the automotive industry, to provide improved polymer composite materials offering additional inherent strength characteristics.

### SUMMARY OF THE INVENTION

In accordance with the general teachings of the present invention, a polymer composite insert is provided. The insert preferably comprises at least one metal mesh component and at least one polymer component.

Additionally, the present invention preferably provides a method of manufacturing and forming a polymer composite insert. The method preferably comprises laminating or coating, either fully or partially, a metal mesh component with a polymer component.

Additionally, the present invention preferably provides a vehicle component part, wherein the vehicle component part preferably comprises at least one coated metal mesh component insert and at least one polymer component.

In accordance with a first embodiment of the present invention, a polymer composite is provided, comprising: (1) at least one metal mesh component; and (2) at least one polymer component.

In accordance with a second embodiment of the present invention, a method of forming a polymer composite is provided, comprising laminating a metal mesh component with a polymer component.

In accordance with a third embodiment of the present invention, a vehicle component is provided, comprising: (1) at least one metal mesh component; and (2) at least one polymer component.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional view of one embodiment of a polymer composite;

FIG. 2 is a cross-sectional view of an alternate embodiment of a polymer composite;

FIG. 3a is a top plan view of one embodiment of a mesh support;

FIG. 3b is a top plan view of a first alternate embodiment of a mesh support;

FIG. 4 is a top plan view of a second alternate embodiment of a mesh support;

FIG. 5 is a graphical view of the impact performance characteristics of a first sample having a mesh support, in accordance with the general teachings of the present invention, incorporated therein;

FIG. 6 is a graphical view of the impact performance characteristics of a second sample having a mesh support, in accordance with the general teachings of the present invention, incorporated therein;

FIG. 7 is a graphical view of the impact performance characteristics of a third sample having a mesh support, in accordance with the general teachings of the present invention, incorporated therein;

FIG. 8 is a graphical view of the impact performance characteristics of a fourth sample having a mesh support, in accordance with the general teachings of the present invention, incorporated therein;

FIG. 9 is a graphical view of the room temperature impact performance characteristics, expressed in terms of in-lbs. of energy, of a fifth sample having a mesh support, in accordance with the general teachings of the present invention incorporated therein;

FIG. 10 is a graphical view of the room temperature impact performance characteristics, expressed in terms of lbs. of load, of a sixth sample having a mesh support in accordance with the general teachings of the present invention incorporated therein;

FIG. 11 is a graphical view of the −30° C. impact performance characteristics, expressed in terms of lbs. of load, of a seventh sample having a mesh support in accordance with the general teachings of the present invention incorporated therein;

FIG. 12 is a graphical view of the −30° C. impact performance characteristics, expressed in terms of in-lbs. of energy, of an eighth sample having a mesh support in accordance with the general teachings of the present invention incorporated therein;

FIG. 13 is a fragmentary perspective view of a wheel well assembly having a mesh support incorporated therein, in accordance with one presently preferred embodiment of the present invention;

FIG. 14 is a fragmentary top plan view of a wheel well assembly having a mesh support incorporated therein, in accordance with a second presently preferred embodiment of the present invention;

FIG. 15 is a cross-sectional view of a floor pan, having a mesh support incorporated therein, to which the present invention can be mounted; and

FIG. 16 is a cross-sectional view of a presently preferred embodiment of the present invention, schematically showing a wheel assembly having a mesh support incorporated therein.

### DETAILED DESCRIPTION OF THE PREFERRED EMBODIMENT

The following description of the preferred embodiment(s) is merely exemplary in nature and is in no way intended to limit the invention, its application, or uses.

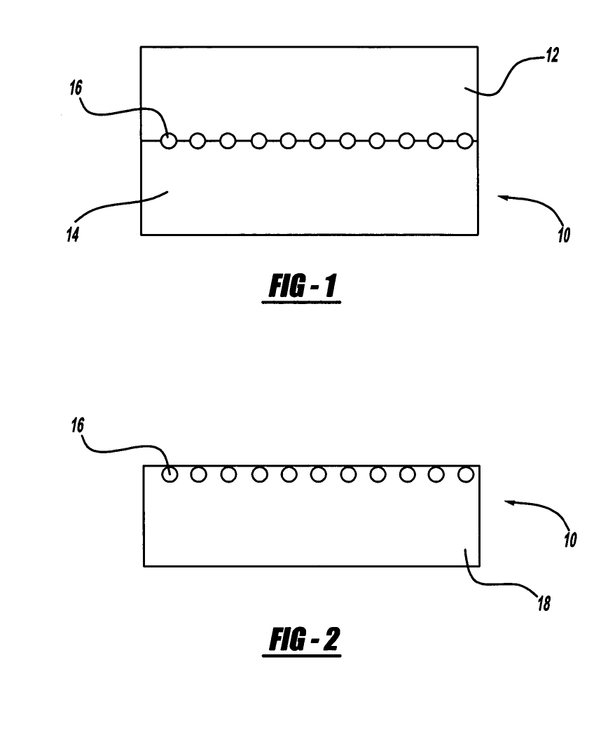

FIG. 1 shows a polymer composite insert, generally shown at 10. The composite 10 preferably includes a first polymer component 12 and an optional second polymer component 14. A metal mesh component 16 is preferably interposed between the polymer components 12 and 14.

The polymer components 12 and 14 can preferably comprise any suitable polymer. Suitable polymers can preferably include, without limitation, polyamides such as but not limited to nylon 6, nylon 6/6, nylon 6/6/6, polyolefins such as but not limited to polyethylene or polypropylene, syndiotactic vinyl aromatic polymers such as but not limited to syndiotactic polystyrene (SPS) and any blends thereof. Other potential polymers preferably include, without limitation, polyesters, polyesteramides, polyarylates, polyurethane, polyureas, epoxies, polyphenylene sulfides, polyetherimides, polycarbonate ABS, and acrylics. Combinations of these polymers can also be used. Additionally, it will be appreciated that filled polymers, e.g., those filled with glass or carbon fiber, mineral, or mineral-glass combinations, mesh, weaves and mats, can also be used as the polymer components 12, 14, respectively.

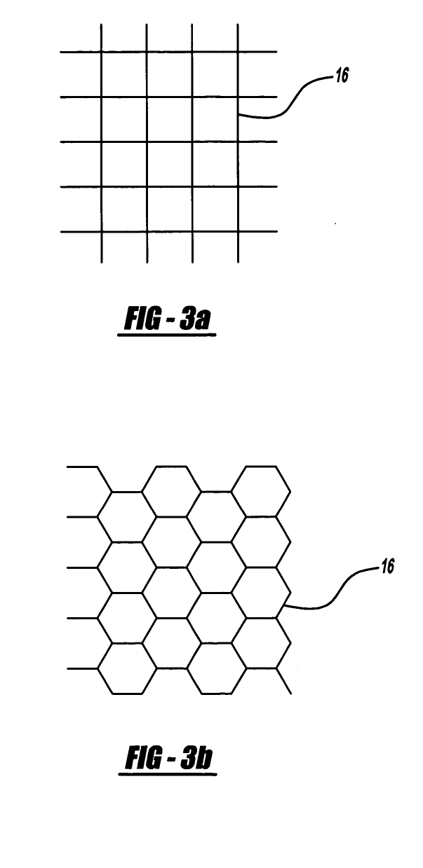

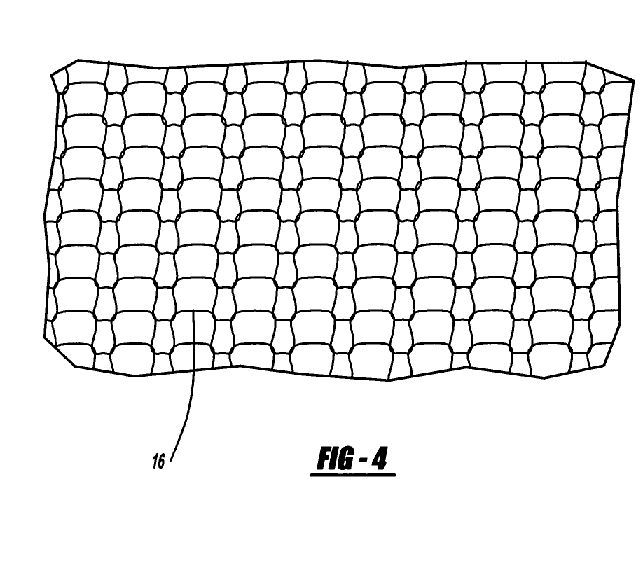

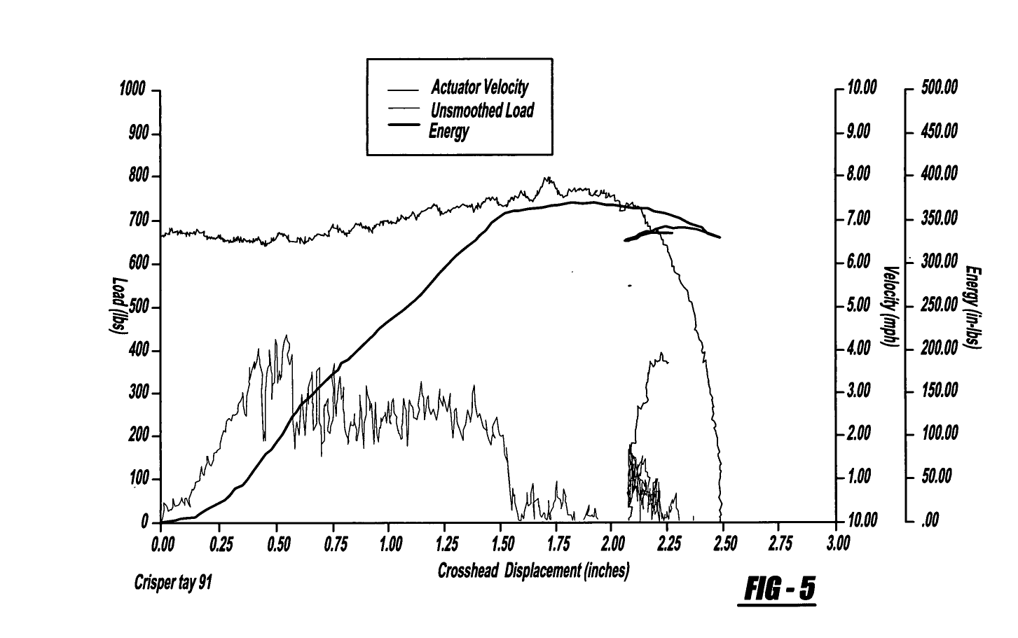

The metal mesh component 16 can preferably comprise a square mesh, such as that shown in FIG. 3a. Additionally, the metal mesh component 16 can preferably have additional configurations such as hexagons as shown, for example, in FIG. 3b. Alternatively, the metal mesh component 16 can preferably comprise a series of interlocking loop-like members, such as that shown in FIG. 4. Although a series of alternating large and small rectangular loop-like members are shown, it should be appreciated that the loop-like members can be configured in any number of shapes and/or sizes. Furthermore, it will be appreciated that any shape of metal mesh component 16 can be used within the scope of the present invention.

Any type of suitable metal can preferably be used for the mesh component 16. It is preferable that the mesh component has a wire diameter in the range of about 0.002 inches to about 0.20 inches. Additionally, it is preferred that the mesh opening size be in the range of about 0.025 inches to about 4 inches. The mesh component 16 can preferably comprise a knit, weave, mat, or a screen.

It is preferable that the metal mesh component 16 be laminated to, or encapsulated by, the polymer components 12 and/or 14. The metal mesh component 16, as shown in FIG. 1, is preferably sandwiched, or coated, by or between the one or two polymer components 12 and 14. It can be made, by way of a non-limiting example, by compression molding the one or two polymer components 12 and 14, together with the mesh component 16 between them at the processing temperature of the polymer, or the mesh can be coated with a suitable polymer using an extrusion coating process which utilizes calendering rolls to set the thickness of the polymer-metal mesh composite. Other suitable laminating or coating methods for full or partial coating or encapsulation can also be used.

FIG. 2 shows an alternate embodiment. In FIG. 2, the metal mesh component 16 is located on only one side of the polymer component 18. Polymer component 18 is preferably compositionally and functionally similar to polymer components 12 and/or 14. In the embodiment of FIG. 2, the polymer component 18 is laminated to the metal mesh component 16 by placing the metal mesh component 16 directly on one side of the mold cavity and molding the polymer component 18 about the metal mesh component 16. Conversely, a pre-laminated or pre-coated metal mesh “insert” can be placed into a tool and the component part (e.g., polymer) molded around, or into, the insert.

Any suitable processing techniques can be used to make the composite insert 10. Preferable processing techniques for a metal mesh composite insert combined with a molded part comprise, without limitation, injection molding, injection-compression molding, blow molding, reaction injection molding, thermal forming, and compression molding. The metal mesh component 16 can also be added to the molded part using mechanical methods such as hot plate welding, sonic welding, and the like. The metal mesh component 16 can also be added using an adhesive such as one- or two-component polyurethanes, epoxies, acrylics, and the like.

Polymer composites made in accordance with the present invention can be formed in virtually any configuration. They are particularly well adapted for use in automotive applications that undergo a dynamic load. These include, without limitation, door panels, rear floor pan assemblies, seat storage compartments, under floor battery bins, and other under floor projections including floor pan closures. Additionally, the present invention has applications under the hood such as in connection with air induction systems, valve covers, and the like. Other examples of use of the present invention include rocker panels, bumper covers, and bumper systems. Additionally, instrument panels and/or instrument panels topper pads can also be formed from the polymer composite. It will be appreciated that the present composite can be used in any suitable area of the vehicle. The pre-coated polymer metal mesh insert can also be itself formed to make an automotive component. The coated polymer-metal mesh can be used by itself or as a substrate for any covered interior trim component, such as but not limited to pillar trim, headliner countermeasures, door panel trim, and the like.

Use of a polymer composite insert 10 in accordance with the present invention provides enhanced energy management to a vehicle component. Enhanced energy management results from an improvement in energy management through a reduction in rebound. Further, there is preferably a dissipation of energy through the metal mesh component 16.

Additionally, the use of a composite can aid in the retention of the integrity of the component following an impact that can break or shatter the polymer component. The metal mesh component 16 can help hold the automotive component together as well as the objects contained therein during such an impact.

It will also be appreciated that the use of a metal mesh component 16 can provide the ability to add thermal conduction (heat transfer) and electrical conduction to the polymer composite. Such heat transfer can be useful to provide surface heating by use of resistance heating or the application of heat from the vehicle's power source. Additionally, heat transfer can be used to cool a vehicle interior, or the vehicle power systems by allowing airflow or convection to transfer heat from or out of the vehicle. This can be accomplished by exposing the metal mesh of any component made in accordance with the above teachings and the heat source connected to the metal mesh component 16 that acts as a heat sink.

It will be appreciated that the heat transfer rate of any vehicle component made in accordance with the present invention could be modified to slow heat-in rates to the vehicle and increase heat-out rates by using a visible or non-visible metal mesh 16 as part of the vehicle design. A visible metal mesh component 16 is accomplished by placing the metal mesh component 16 adjacent the mold cavity and molding about the mesh, such as the embodiment shown in FIG. 2. Production of a component having a non-visible metal mesh is accomplished by placing the metal mesh component 16 between the polymer components, such as the embodiment of FIG. 1.

Finally, the use of the metal mesh component 16 can result in radio frequency shielding. This can be particularly useful in instrument panel components, such as topper pads.

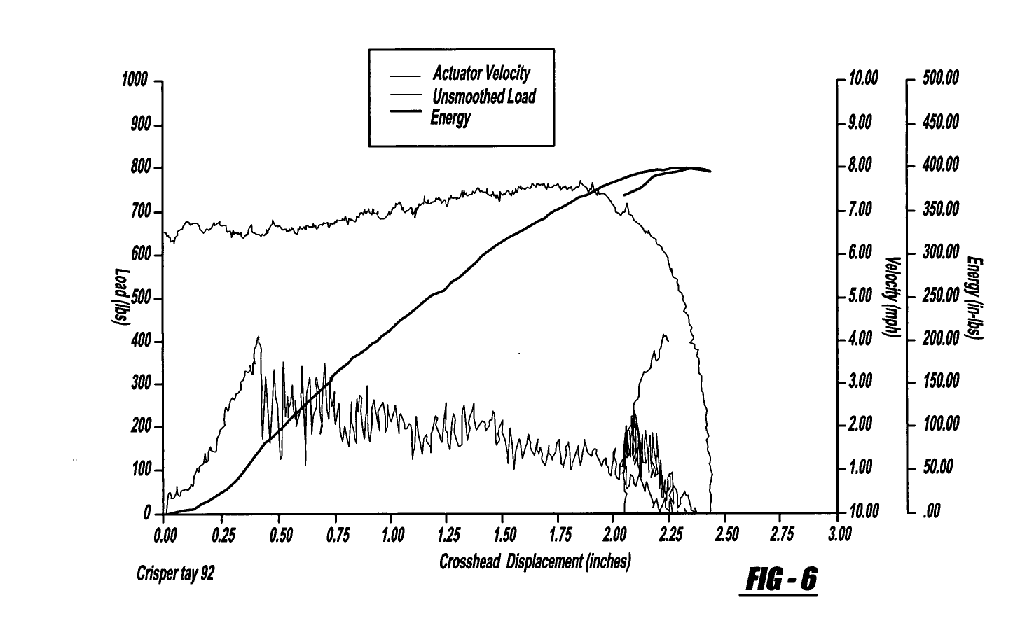

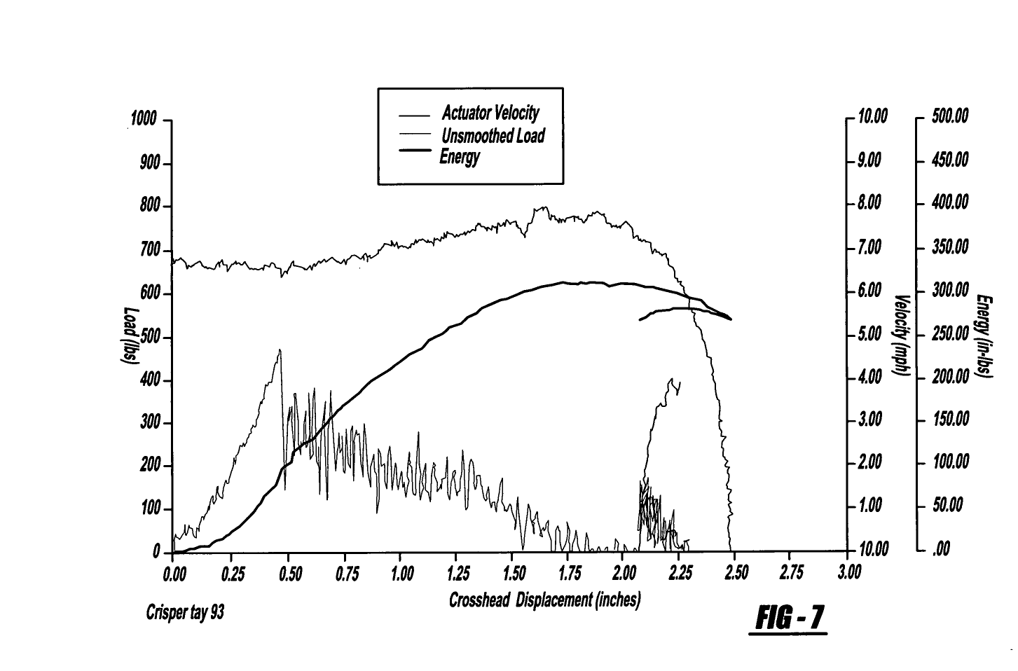

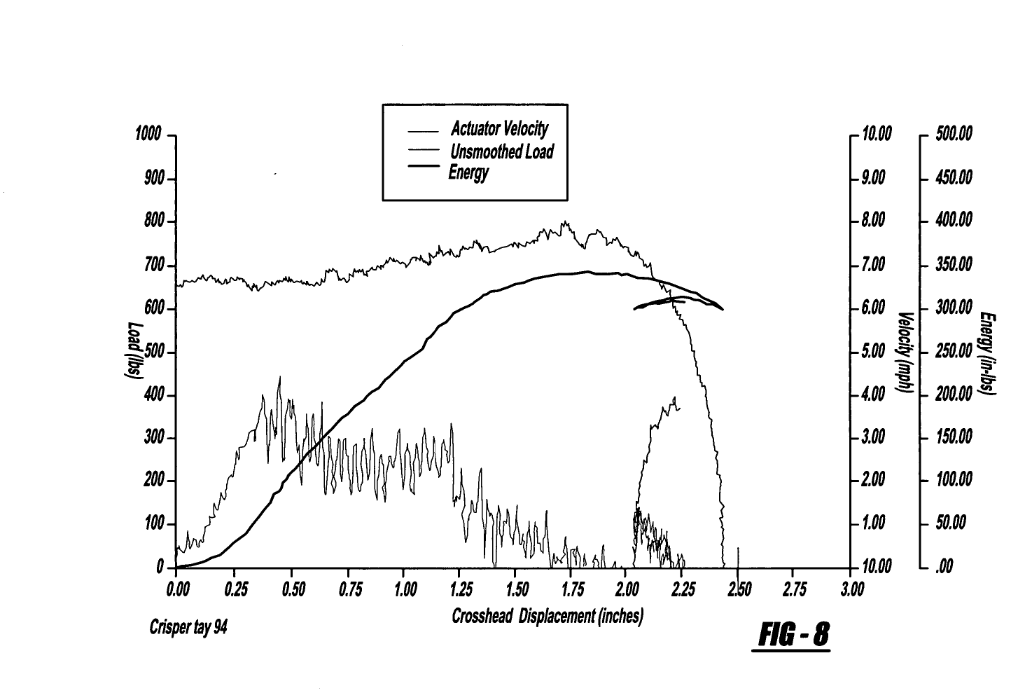

Initial plaque impact testing data, run at an impact velocity of 8 mph using a 2 -inch diameter impactor, shows that unfilled polypropylene copolymer will shatter at approximately 80 in-lbs. of force at −30° C. The test plaque split into pieces. Tests were then conducted on a polymer composite of the type shown in FIG. 1. Four samples were taken from crisper trays formed with the polymer composite of the present invention. The samples were prepared by using the same neat polypropylene copolymer with 1-inch hex-shaped iron wire mesh at a 0.8 mil. diameter (14 gauge). The samples were prepared by compression molding one plastic component 12, with the mesh 16 under it to a thickness of 3.5 mm. at the polypropylene processing temperatures. The highest impact energy achieved was approximately 300 in-lbs. at −30° C. with the load being approximately 560 lbs., wherein the test plaques dented and developed a crack. The load, crosshead displacement, velocity and energy performance characteristics for these four samples are shown in FIGS. 5-8.

Further impact testing was completed using an injection-molded crisper tray manufactured from 30% glass reinforced polypropylene, Dow IMPP 3702. Polymer coated metal mesh inserts 0.7 mm thick were prepared using three different Dow polymers: (1) Dow copolymer PP C719-35RNHP; (2) Dow 30% LGF PP DLGF 9300; and (3) Dow IMPP DGF-3702. The wire mesh selected was mild steel knit using 0.011-inch thick wire with 6 to 8 opening per inch, 60 density, single layer. Inserts were prepared in a laboratory compression molding process using steel forms, woven wire mesh, and polypropylene resin. The steel forms are typically 1 mm and 0.75 mm thick, but of various lengths and widths. Woven wire meshes are composed of either mild galvanized steel or stainless steel. Woven mesh and polypropylene resin (either pellets or pre-molded coupons) are placed within the steel forms, compressed and heated to approximately 200 psi and approximately 420° F., respectively, for approximately 30 minutes.

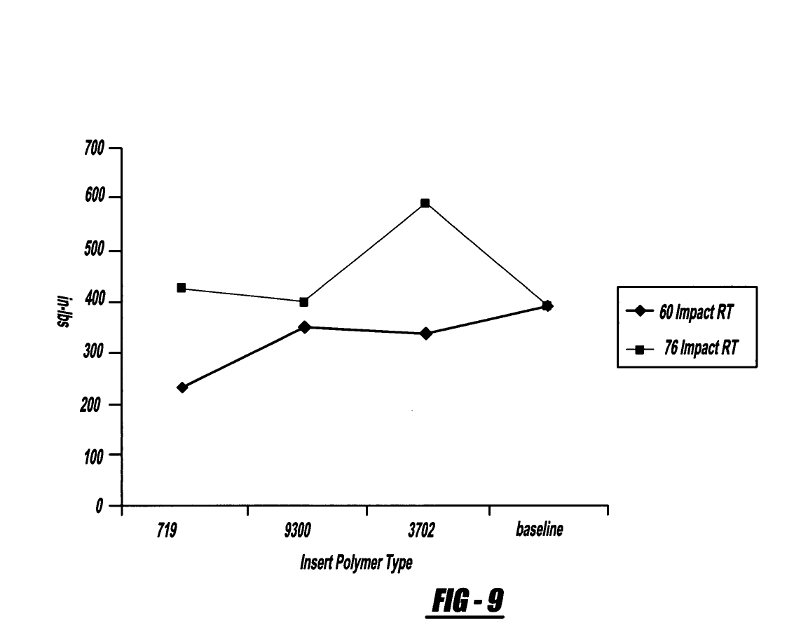

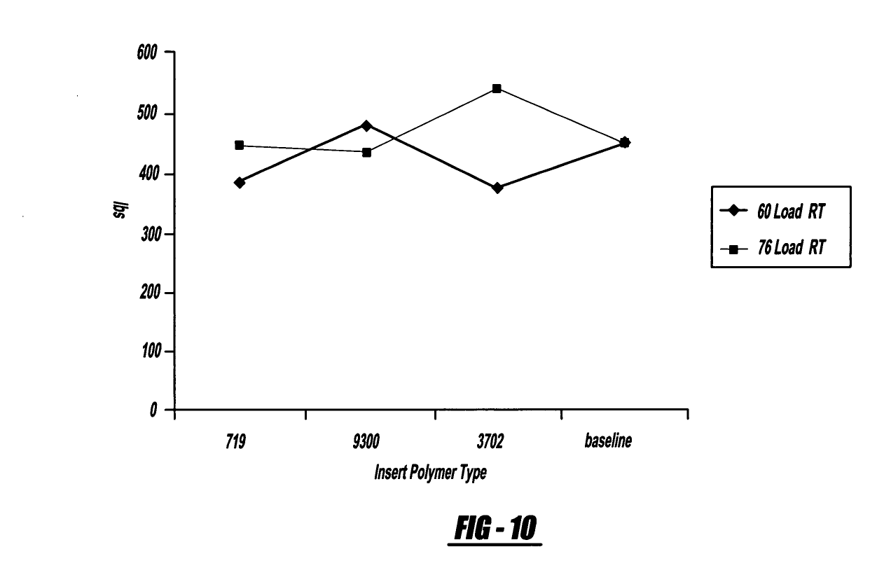

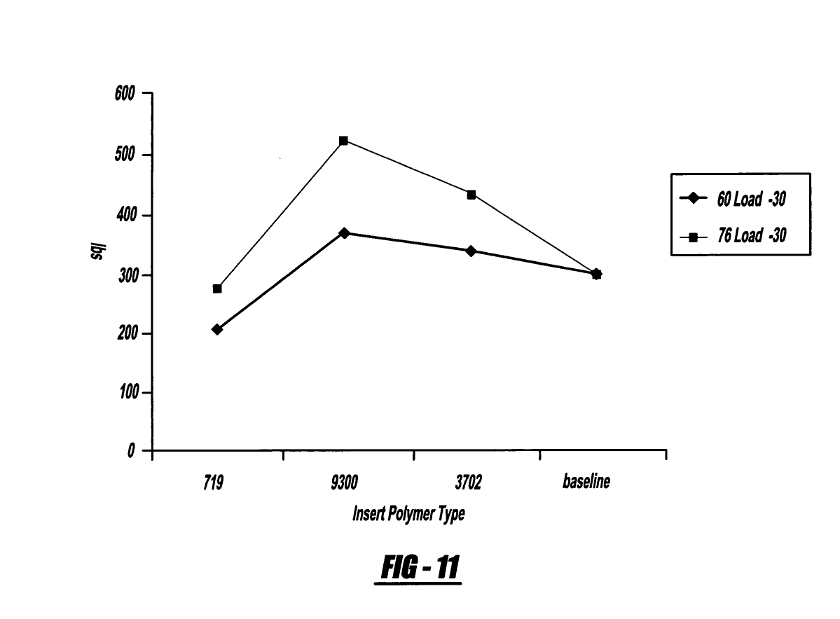

Trays were injection molded using the three types of PP mentioned above for the insert. Three samples of each were tested at ambient temperature and at −30° C., using a 2 -inch diameter impactor, at 8 mph velocity. At room temperature, all sample impacts visually resembled the baseline tray that had no wire-polymer insert. An increase was observed in impact load values with the longer glass fiber reinforced insert, DGLF 9300, and an increase in deflection when using the neat polypropylene insert, C710-35RNHP. The novel behavior was observed at −30° C. The baseline tray (no inserts) impacts were brittle failures with broken off shards/pieces that flew free from the tray and left an opening. The sample trays with wire-polymer inserts from all three polypropylene types exhibited cracking and the wire-polymer insert held all pieces in place. The recorded impact loads increased with the stiffness of the wire-polymer inserts, as did the impact energies. The energy performance characteristics for these three samples and the baseline are shown in FIGS. 9 and 12, and the load performance characteristics for these three samples and the baseline are shown in FIGS. 10 and 11.

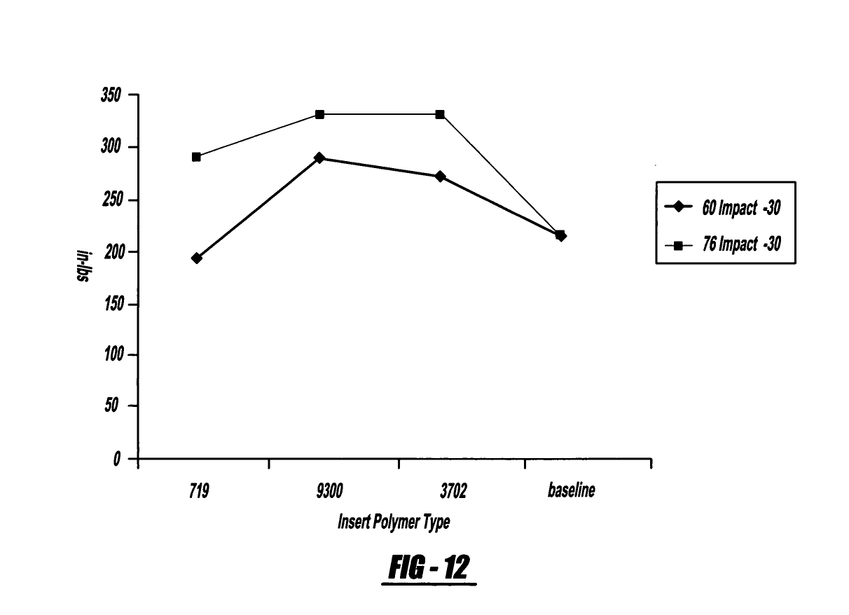

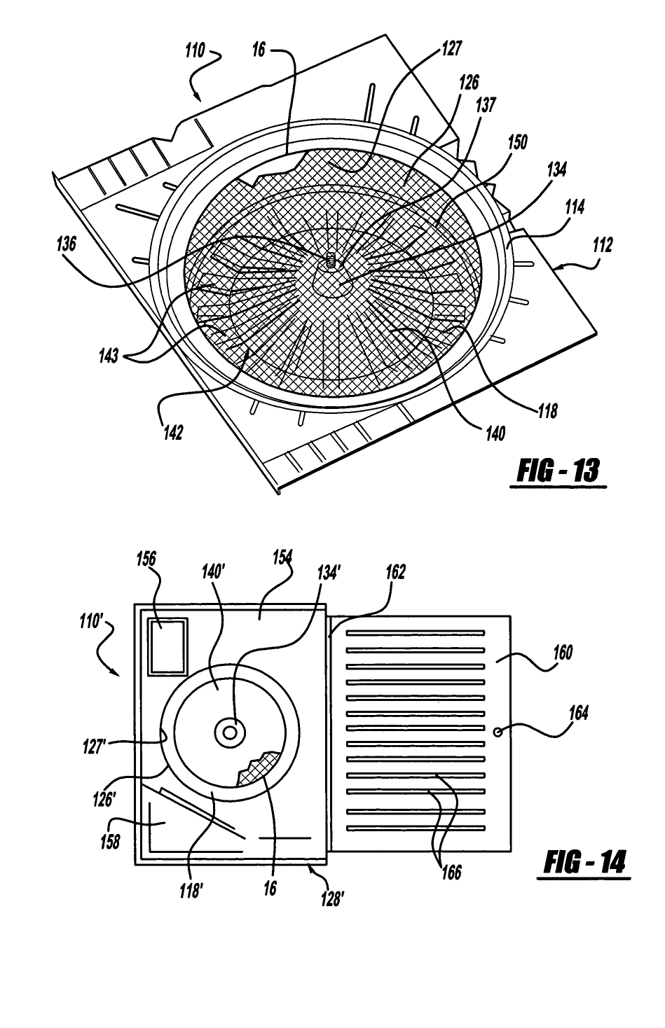

The polymer composite inserts of the present invention are particularly suitable for use as, or in, automotive components. By way of a non-limiting example, a composite wheel well assembly, employing the polymer composite insert of the present invention, is generally shown at 110 in FIGS. 13 and 16. Any portion, or the entirety of the assembly 110 can be provided with a coated and/or uncoated metal mesh component 16. The metal mesh component 16 can be disposed below the surface of the assembly 110 (similar to FIG. 1), or can be disposed on or near the surface thereof (similar to FIG. 2).

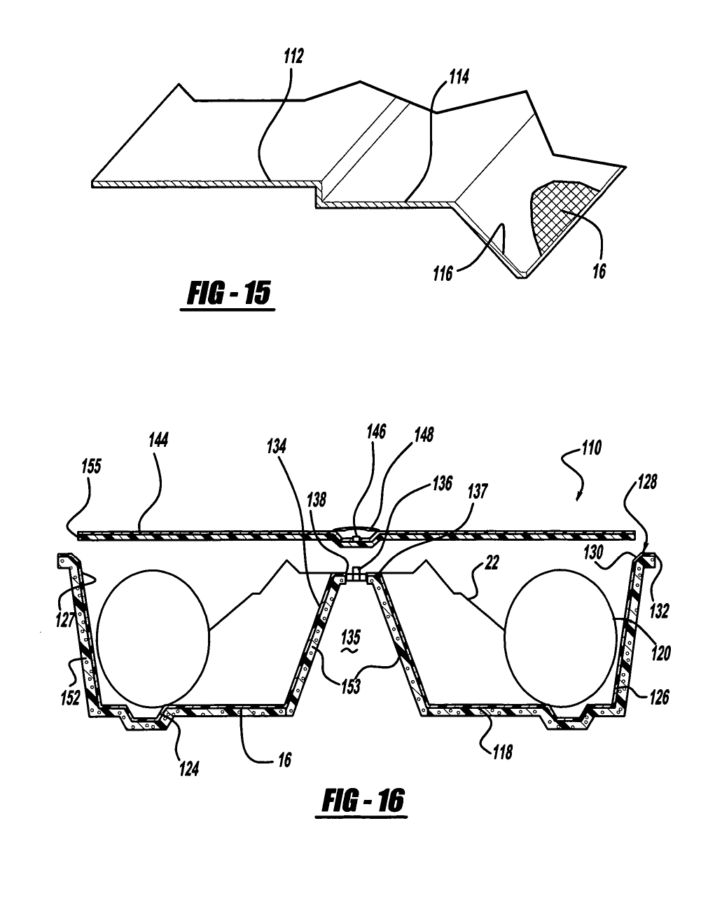

The assembly 110 is preferably intended for connection with a vehicle floor pan 112, as best shown in FIGS. 13 and 15. The floor pan 112 preferably defines an opening having a desired configuration. The periphery of the opening can preferably include a surface 114 to which the composite wheel well assembly 110 can be secured. A second surface 116 can also preferably be provided. The second surface 116 can preferably be angled with respect to the surface 114. The second surface 116 can preferably provide a second mounting surface for the wheel well assembly 110. The second surface 116 also preferably helps locate the composite wheel well assembly 110 in the opening of the vehicle floor pan 112. The mounting surface 114 is preferably spaced preferably by a short distance from the uppermost surface of the floor pan 112. In this manner, the composite wheel well assembly 110 can preferably be mounted on the surface 114 such that it is flush with the top surface of the floor pan 112.

The composite wheel well assembly 110 preferably comprises a floor 118. The floor 118 preferably provides a surface for receiving a vehicle tire 120 and supporting the same within the wheel well assembly 110. Preferably, its floor 118 is flat. The vehicle tire 120 is preferably attached to a wheel rim 122 as schematically represented in FIG. 16. As shown, the tire 120 is preferably supported on the floor 118.

As best seen in FIG. 16, the floor 118 can preferably include molded compartments or cavities 124. The compartments 124 can preferably be molded into the floor 118. These molded-in compartments 124 can preferably extend below the floor surface 118 upon which the vehicle tire 120 rests. The compartments 124 can preferably be molded to accept and store a wide variety of items, such as a vehicle jack, lug wrench, safety equipment, or the like. It is preferable that the tire 120 still be supported by a flat section of the floor 118, even when a storage compartment 124 is present.

At least one sidewall 126 preferably extends upwardly from the floor 118. As best shown in FIGS. 13 and 16, the sidewall 126 preferably comprises a single annular sidewall 126. It will be appreciated that multiple sidewalls 126 forming a variety of different shapes can preferably be used. The sidewall 126 preferably extends upwardly from the floor 118 and is flared slightly outwardly to facilitate installation and removal of a wheel from the wheel well assembly 110. The sidewall 126 and floor 118 preferably define a cavity or wheel well 127 therein.

The sidewall 126 preferably includes a mounting flange generally indicated at 128 at its distal end. Preferably, the mounting flange extends around the entire periphery of the sidewall 126. The mounting flange 128 can preferably include one or more mounting sections 130, 132 designed to mate with the mounting surfaces 114, 116 of the floor pan 112. In this manner, the mounting sections 130, 132 of mounting flange 128 preferably overlie the mounting surfaces 114, 116 of the floor pan 112. The mounting sections 130, 132 of the mounting flange 128 can preferably be secured with the mounting surfaces 114, 116 of the floor pan 112 with the use of suitable adhesives. Alternatively, or in addition to adhesives, mechanical fasteners can preferably be used to secure the mounting sections 130,132 of the mounting flange 128 with the mounting surfaces 114, 116 of the vehicle floor pan 112. Currently preferred adhesives include polyurethane adhesives and LES (Low Energy Surface) adhesives. LES (Low Energy Surface Adhesive) refers to alkyl borane amine complex initiated acrylic adhesives. Representative of preferred LES adhesives are described in various patents including U.S. Pat. Nos. 5,106,928, 5,143,884, 5,286,821, 5,310,835, 5,376,746, U.S. Pat. No. 5,539,070; U.S. Pat. No. 5,690,780; and U.S. Pat. No. 5,691,065. These are also described in PCT application No. WO 2001144311 and the corresponding U.S. Ser. No. 10/310,169 filed Dec. 4, 2002. It will be appreciated, however, that any suitable adhesive can be used.

In the preferred embodiment, a post 134 preferably extends upwardly from the floor 118. The post 134 is preferably frustoconical. It will be appreciated, however, that the post can take any geometric configuration and can be of any size. The post 134 preferably extends upwardly from the floor 118 intermediate to sidewall 126. Preferably, the post 134 extends upwardly from the center of the floor 118. In this manner, the post 134 preferably serves to center the spare wheel in the wheel well 127. The post 134 preferably includes a connector, such as a bolt or stud 136 extending outwardly at the top end thereof. The bolt or stud 136 is preferably threaded into an opening 138 provided in the top surface 137 of the post 134.

As best shown in FIG. 13, in one embodiment, the floor 118 can preferably include a segment 140 extending upwardly from the floor 118 to the post 134. The segment 140 is preferably frustoconical and accommodates the rim assembly 122 of the spare tire assembly. The post 134 preferably extends upwardly from the center of floor segment 140. The area under any frustoconical floor segment 140 and the post 134 preferably creates a storage space 135, best seen in FIG. 16. The storage space 135 can preferably receive any variety of items to be stored. As shown, the storage space 135 can preferably be accessed from underneath the assembly 110. Alternatively, the storage space 135 can preferably be accessed from above the assembly 110. In such a case, a suitable access panel (not shown) can preferably be included in either the floor 118 or post 134. The storage space 135 can preferably take any suitable shape. The assembly 110 can also preferably include a suitable closure (not shown) for covering the storage space 135.

The floor 118 preferably includes a plurality of stiffening members 142 thereon. The stiffening members 142 preferably comprise ribs 142. Alternatively, the stiffening members 142 can preferably comprise gussets, convolutions, or any other suitable strengthening element that provides surface stiffening. The stiffening members 142 can also preferably aid in centering the spare wheel in the spare wheel well. In certain instances, the stiffening members can preferably project upwardly to aid in center the spare wheel. Further, it will be appreciated that the stiffening members 142 can preferably take any geometric configuration. Further, there is no need for the geometry of the stiffening members 142 to be symmetrical. The stiffening members 142 preferably provide stiffness to the assembly and further allow for contact between the stiffening members 142 and the rubber-only portions of the tire 120. This preferably aids in noise abatement within the wheel well 127. The stiffening members 142 preferably extend on the floor 118 and any additional flooring segments 140. Further, the stiffening members 142 preferably provide structure to the assembly 110 which can be optimized to improve the rear crush zone and fuel tank impact characteristics. While not shown in the drawings, the sidewalls 126 and post 134 can also preferably include ribs thereon.

The post 134 is preferably adapted to engage the central hub portion of the rim assembly 122 of the spare wheel. The post 134 preferably centers the rim assembly 122 and tire 120 and prevents the spare wheel assembly from shifting within the wheel well 127.

The wheel well assembly 110 can preferably further include a top 144 for covering the wheel well 117. The top 144 preferably includes a threaded fastener, such as a nut 146 for receiving the bolt 136. The top 144 can thus preferably be threadably secured to the bolt 136 in the post 134 for retaining the top 144 on the assembly 110. A handle 148 is also preferably provided to allow the top 144 to be secured onto the bolt 136. Alternatively, hand holds, not shown, can preferably be formed into the top 144, such as by molding, to permit a grasp location for the user to secure the top 144 with the bolt 136. In yet another alternate embodiment, the top can preferably have only an opening for allowing the bolt 136 to pass through. A nut, such as a large wing nut, is then preferably fastened on the bolt 136 to secure the top 144. As shown in FIG. 16, when the top 144 is installed, the top 144 is preferably supported on the post 134. Thus, the post 134 preferably aids in holding the top 144. Alternatively, the top 144 can preferably be spaced from the post 134 and supported by the tire within the wheel well.

The floor 118 can preferably further include a ledge portion 150. This ledge portion 150 preferably provides a location for providing electrical equipment integration, such as, for example, to locate an antenna for a GPS, compass, phone or radio. The ledge portion 150, including the electrical component integration, could preferably be integrally formed with the floor 118. Alternatively, the ledge portion 150 can preferably be separately formed and the secured to the floor 118 or sidewall 126, such as by a snap fit or the use of suitable adhesives.

Preferably, the floor 118, sidewall 126, post 134, and any additional floor segments 140 are preferably formed of a composite material. In the preferred embodiment, the composite materials used include, without limitation, glass-filled, mineral filled, or insert molded glass mesh, metallic mesh, polymer mesh, or mineral-glass filled combinations of semi-crystalline or amorphous polymers and include but are not limited to, polyamides such as nylon 6, nylon 6/6, nylon 6/6/6, polyolefins such as polyethylene or polypropylene, syndiotactic vinyl aromatic polymers such as syndiotactic polystyrene (SPS) and any blends thereof. Other potential polymers include polyesters, polyesteramides, polyarylates, polyurethane, polyureas, polyphenylene sulfides, and polyetherimides. It will be appreciated that other thermoplastic or thermoset composite materials can be used within the scope of the present invention. Each of the floor 118, compartments 124, sidewall 126, mounting flange 128, post 134, and any additional floor segments 140, are preferably integrally formed such as by injection molding. The compartments can also be formed by blow-molding. It will be appreciated, however, that any technique can be used to integrally form the components. The compartments can also be formed from steel, aluminum, or laminates of the two in conjunction with polymeric materials.

As discussed above, the floor 118 can preferably include integrally molded compartments 124. These compartments 124 are shown to be below the bottom surface of the floor 118. It will be appreciated, however, that the molded compartments 124 can be located alternatively, or additionally, on any additional flooring segments 140, or on the sidewall 126.

In order to install the wheel well assembly 110 in a vehicle, the vehicle and the floor pan 112 with an opening therein is preferably provided. The floor pan 112 preferably includes surfaces 114, 116 for receiving the wheel well assembly 110. The wheel well assembly 110 is preferably inserted through the top of the opening in the floor pan 112 until the mounting flange 128 engages the surfaces 114, 116 of the floor pan. Adhesives can preferably be applied to either or both of the underside of the mounting flange 128 and surfaces 114, 116 prior to installation of the assembly 110. Once the adhesive has cured, the wheel well 127 is preferably retained in the floor pan 112.

Alternatively, or additionally, mechanical fasteners are preferably applied to the mounting flange 128 and floor pan surfaces 114, 116 to secure the wheel well assembly 110 to the floor pan 112. The assembly 110 can preferably be inserted with the tire 120 and rim 122 already placed in the wheel well 127. Alternatively, the tire 120 and rim 122 can preferably be inserted after the assembly has been secured to the floor pan 112. Similarly, the top 144 can preferably be pre-installed with the remainder of the wheel well assembly 110 or can be secured to the bolt 136 after the remainder of the assembly 110 has been secured to the floor pan 112.

It will also be appreciated that elements, such as seals or the like (not shown) can preferably be interposed between the mounting flange 128 and the floor pan surfaces 114, 116. In such a case, the adhesive can also be used to secure the seal in place.

The assembly 110 can also preferably include a sound abatement layer. More specifically, FIG. 16 also shows a sound abatement layer 152 preferably secured to the sidewall 126 and floor 118 of the wheel well assembly 110. It is preferred that the sound abatement layer 152 does not contact the mounting flange 128. Similarly, a sound abatement layer 155 can preferably be secured to one or both sides of the top 144. The sound abatement materials can be molded in placed or foamed in place. Preferably, the noise abatement materials include any adequate foam, filled foam, filled elastomeric sheet, or injection moldable filled material.

It will also be appreciated that a carpet material, not shown, can preferably be placed on the top surface of the top 144. The carpet is used to match the carpet in the cargo hold area of the vehicle below which the wheel well assembly 110 is typically located. Each of the sound abatement layers 152, 154, and carpet layer preferably provide additional noise abatement properties to the wheel well assembly 110.

FIG. 14 shows an alternate wheel well assembly. Like numerals will be used to represent the like components, however, a prime designation will be added to the numbers to distinguish the various embodiments. As with the previously described assembly 110, any portion, or the entirety of the assembly 110′ can be provided with a coated and/or uncoated metal mesh component 16. The metal mesh component 16 can be disposed below the surface (similar to FIG. 1) of the assembly 110′, or can be disposed on or near the surface thereof (similar to FIG. 2).

The wheel well assembly 110′ is preferably adapted for engaging a rectangular opening in a floor pan of the vehicle. The assembly 110′ preferably includes a mounting flange 128′. The mounting flange 128′ is preferably connected to deck section 154. The deck section 154 is preferably connected to the top of an annual sidewall 126′. A wheel well 127′ is preferably formed by an annular sidewall 126′ extending below the surface of the floor segment 154. The sidewall 126′ preferably terminates in a floor 118′. A floor segment 140′ is preferably generally frustoconical and extends inwardly and upwardly from the floor 118′. A frustoconical post 134′ is also preferably provided. The post 134′ preferably extends upwardly preferably from the center of the floor segment 140′, as described above. The post 134′ can preferably include a connection for receiving a member to secure the spare wheel assembly in the wheel well 127′.

Generally, the annular sidewall 126′, floor 118′, floor segment 140′, and post 134′ define the wheel well 127′. The wheel well 127′ is preferably the same as that set forth above. Though not shown in FIG. 14, the floor 118′ and floor segment 140′ can preferably include a plurality of stiffening members such as ribs.

Additionally, the wheel well assembly 110′, shown in FIG. 14, preferably includes an area for molding in additional compartments. For example, a compartment 156 can preferably be molded into the deck 154. That is, the compartment 156 can preferably be molded to extend below the deck 154 top surface. The compartment 156 can preferably be used to store any of a variety of tools and safety items. Further, the compartment 156 can preferably be large enough to hold electronic equipment such as CD players. It will be appreciated that any number of such compartments can be provided for various purposes. Similarly, a tool receptacle, such as a molded in jack holder 158, can also preferably be provided. The tool receptacle 158 can preferably be molded in the shape of the tool to be received. Alternatively, the tool receptacle 158 can preferably just comprise clips extending upwardly to receive the tool and secure it such as by a snap fit. Each of these additional components 156 and tool receptacles 158 are preferably integrally formed with the wheel assembly 110′. Further, the compartments 156 or tool receptacles 158 can preferably take any configuration and can be used to store any items.

A deck lid 160 is also preferably provided. The deck lid 160 is preferably integrally formed with the remainder of the wheel well assembly 110′. It is preferred that the latch 164 be molded into the deck lid 160 for securing the deck lid to the deck 154. Preferably, a mechanical fastening is provided. That is, the latch 164 can preferably include a latch member having a post and a transverse leg at the distal end of the post. The deck 154 can preferably include a contoured opening for allowing the leg to pass therethrough. Upon rotation of the latch, the leg will also preferably rotate and engage the underside of the deck 154 to preferably prevent opening of the lid 160. To open the lid 160, the latch is preferably rotated until the leg aligns with the opening allowing it to pass therethrough. Any alternate latch can preferably be used that retains the lid 160 on the deck. A plurality of strengthening ribs 166 is preferably molded into the deck lid 160. A living hinge 162 preferably integrally connects the sidewall 126′ with the deck lid 160. The deck lid 160 is preferably for covering the wheel well 127 and deck 154. The lid 160 also preferably provides a load floor for the vehicle.

A latch mechanism 164 is preferably included to secure the deck lid 160 with the remainder of the wheel well assembly 110′.

As above, a sound abatement material can preferably be molded to the bottom of the assembly 110′ and on the inside on the deck lid 160. Further, carpeting can preferably be placed on opposite side of the deck lid 160.

Further, preferably the assembly 110′ is preferably integrally molded. The materials can be the same as that used above. Due to the difficulty in molding a living hinge containing a filler material, a filler material, such as glass fibers can or can not be used in connection with this embodiment.

Installation of the wheel well assembly 110′ is preferably the same as that set forth above except, because the lid 160 is integral with the assembly 110′, it will be installed at the same time as the remainder of the wheel well assembly.

Presently, the preferred embodiments of the invention have been described in an illustrative manner. It is to be understood that the terminology used is intended to be in the nature of words of description. Obviously many modifications and variations are possible in light of the above teachings. It is to be understood that, within the scope of the appended claims, the invention can be practiced other than as specifically described.

1. A polymer composite, comprising:
at least one metal mesh component; and
at least one polymer component.

2. A composite as set forth in claim 1, wherein said metal mesh component has a wire diameter in the range of about 0.002 inches to about 0.20 inches.

3. A composite as set forth in claim 1, wherein said metal mesh component has a mesh size in the range of about 0.25 inches to about 4 inches.

4. A composite as set forth in claim 1, wherein said polymer component is selected from the group comprising polyamides, polyolefins, syndiotactic vinyl aromatic polymers, polyesters, polyesteramides, polyarylates, polyurethane, polyureas, polyphenylene sulfides, polyetherimides, polycarbonate, ABS, acrylics, epoxies, and combinations thereof.

5. A composite as set forth in claim 1, wherein said metal mesh component is encapsulated within said polymer component.

6. A composite as set forth in claim 1, wherein said polymer composite comprises a vehicle component.

7. A composite as set forth in claim 6, wherein said vehicle component comprises a wheel well member.

8. A method of forming a polymer composite, comprising laminating a metal mesh component with a polymer component.

9. A method as set forth in claim 8, wherein the laminating step comprises placing the metal mesh component insert into a mold cavity and molding the polymer component part.

10. A method as set forth in claim 8, wherein the laminating step comprises placing the metal mesh component under a polymer or between a first and a second polymer component and compression molding at the processing temperature of the first and second polymer component.

11. A method as set forth in claim 8, wherein said metal mesh component is encapsulated within said polymer component.

12. A method as set forth in claim 8, wherein said polymer composite comprises a vehicle component.

13. A method as set forth in claim 12, wherein said vehicle component comprises a wheel well member.

14. A vehicle component, comprising:
at least one metal mesh component; and
at least one polymer component.

15. A component as set forth in claim 14, wherein said metal mesh component has a wire diameter in the range of about 0.002 inches to about 0.20 inches.

16. A component as set forth in claim 14, wherein said metal mesh component has a mesh size in the range of about 0.25 inches to about 4 inches.

17. A component as set forth in claim 14, wherein said polymer component is selected from the group comprising polyamides, polyolefins, syndiotactic vinyl aromatic polymers, polyesters, polyesteramides, polyarylates, polyurethane, polyureas, polyphenylene sulfides, polyetherimides, polycarbonate ABS acrylics, and combinations thereof.

18. A component as set forth in claim 14, wherein said metal mesh component is encapsulated within said polymer component.

19. A component as set forth in claim 14, wherein said vehicle component comprises a wheel well member.
